(19) United States
(12) Patent Application Publication
(10) Pub. No.: US 2026/0126116 A1
(43) Pub. Date: May 7, 2026

(54) MECHANICAL SEAL AND COOLING STATE ESTIMATION METHOD

(71) Applicant: PILLAR Corporation, Osaka (JP)

(72) Inventors: Koki Fukui, Osaka (JP); Kazuma Adachi, Osaka (JP)

(73) Assignee: PILLAR Corporation, Osaka (JP)

(21) Appl. No.: 19/116,226

(22) PCT Filed: Nov. 16, 2022
(86) PCT No.: PCT/JP2022/042538

§ 371 Date: Mar. 27, 2025

(51) Int. Cl. F16J 15/34

(52) U.S. Cl. CPC F16J 15/3404; F16J 15/3492

(57) ABSTRACT

A mechanical seal includes: a rotary side unit provided on a rotary shaft so as to be rotatable therewith and having a rotary sealing ring; and a stationary side unit provided on a casing surrounding the rotary shaft and having a stationary sealing ring on which the rotary sealing ring slides to seal a sealing target fluid in an inside region in the casing. Sliding portions of the rotary sealing ring and the stationary sealing ring are cooled by a flushing fluid. The mechanical seal includes a temperature difference detection part provided in the stationary side unit and configured to detect a temperature difference between a temperature of a first flushing fluid that is the flushing fluid before cooling the sliding portions and a temperature of a second flushing fluid that is the flushing fluid after cooling the sliding portions.

### TECHNICAL FIELD

The present invention relates to a mechanical seal and a cooling state estimation method.

### BACKGROUND ART

As a seal for sealing a sealing target fluid inside a rotary machine, for example, a mechanical seal described in PATENT LITERATURE 1 is known. The mechanical seal of PATENT LITERATURE 1 includes a rotary sealing ring (rotary ring) provided on a rotary shaft of a rotary machine so as to slide on a stationary sealing ring, and the stationary sealing ring (fixed ring) provided on a housing of the rotary machine. The sliding portions of the rotary sealing ring and the stationary sealing ring are cooled and lubricated by a flushing fluid.

### CITATION LIST

### Patent Literature

PATENT LITERATURE 1: Japanese Laid-Open Patent Publication No. 2021-060079

### SUMMARY OF THE INVENTION

### Technical Problem

In the mechanical seal of PATENT LITERATURE 1, in order to grasp whether or not the sliding portions of the rotary sealing ring and the stationary sealing ring are appropriately cooled by the flushing fluid, it is necessary to disassemble the mechanical seal and visually and directly observe the sliding portions. Therefore, it is difficult to grasp the cooling state of the sliding portions while the mechanical seal is in operation.

The present disclosure has been made in view of such circumstances, and an object of the present disclosure is to provide a mechanical seal and a cooling state estimation method that enable estimation of a cooling state of sliding portions of a rotary sealing ring and a stationary sealing ring by a flushing fluid without directly observing the sliding portions.

### Solution to Problem

(1) The present disclosure is directed to a mechanical seal including: a rotary side unit provided on a rotary shaft so as to be rotatable therewith and having a rotary sealing ring; and a stationary side unit provided on a casing surrounding the rotary shaft and having a stationary sealing ring on which the rotary sealing ring slides to seal a sealing target fluid in an inside region in the casing, sliding portions of the rotary sealing ring and the stationary sealing ring being cooled by a flushing fluid, the mechanical seal including a temperature difference detection part provided in the stationary side unit and configured to detect a temperature difference between a temperature of a first flushing fluid that is the flushing fluid before cooling the sliding portions and a temperature of a second flushing fluid that is the flushing fluid after cooling the sliding portions.

In the mechanical seal of the present disclosure, the temperature difference between the temperature of the first flushing fluid before cooling and the temperature of the second flushing fluid after cooling is detected by the temperature difference detection part. If the temperature difference is relatively large, the heat generation at the sliding portions is increased due to frictional heat, etc., so that the cooling state of the sliding portions can be roughly estimated to be a state where the amount of the flushing fluid supplied to the sliding portions is insufficient. If the temperature difference is relatively small, the heat generation at the sliding portions is reduced to be low, so that the cooling state of the sliding portions can be roughly estimated to be a state where the sliding portions are appropriately cooled by the flushing fluid. Therefore, by detecting the temperature difference by the temperature difference detection part, the cooling state of the sliding portions by the flushing fluid can be estimated without directly observing the sliding portions of the rotary sealing ring and the stationary sealing ring.

(2) Preferably, the mechanical seal of (1) above further includes a control part configured to calculate a coefficient of kinetic friction of the sliding portions, based on the temperature difference.

In this case, since the coefficient of kinetic friction calculated by the control part is closely related to the cooling state of the sliding portions, the cooling state of the sliding portions of the rotary sealing ring and the stationary sealing ring by the flushing fluid can be more accurately estimated from the coefficient of kinetic friction.

(3) In the mechanical seal of (1) or (2) above, preferably, the temperature difference detection part is a thermocouple having a reference contact and a temperature measuring contact, the reference contact is placed so as to be in contact with one of the first flushing fluid and the second flushing fluid, and the temperature measuring contact is placed so as to be in contact with the other of the first flushing fluid and the second flushing fluid.

In this case, the temperature difference between the reference contact and the temperature measuring contact of the thermocouple is the temperature difference between the temperature of the first flushing fluid before cooling and the temperature of the second flushing fluid after cooling. Therefore, by using the thermocouple, the temperature difference detection part can have a simple configuration.

(4) The present disclosure is directed to a cooling state estimation method for, in a mechanical seal including: a rotary side unit provided on a rotary shaft so as to be rotatable therewith and having a rotary sealing ring; and a stationary side unit provided on a casing surrounding the rotary shaft and having a stationary sealing ring on which the rotary sealing ring slides to seal a sealing target fluid in an inside region in the casing, estimating a cooling state of sliding portions of the rotary sealing ring and the stationary sealing ring by a flushing fluid, the cooling state estimation method including a step of detecting, by a temperature difference detection part, a temperature difference between a temperature of the flushing fluid before cooling the sliding portions and a temperature of the flushing fluid after cooling the sliding portions.

In the cooling state estimation method of the present disclosure, the temperature difference between the temperature of the flushing fluid before cooling and the temperature of the flushing fluid after cooling is detected by the temperature difference detection part. If the temperature difference is relatively large, the heat generation at the sliding portions is increased due to frictional heat, etc., so that the cooling state of the sliding portions can be roughly estimated to be a state where the amount of the flushing fluid supplied to the sliding portions is insufficient. If the temperature difference is relatively small, the heat generation at the sliding portions is reduced to be low, so that the cooling state of the sliding portions can be roughly estimated to be a state where the sliding portions are appropriately cooled by the flushing fluid. Therefore, by detecting the temperature difference by the temperature difference detection part, the cooling state of the sliding portions by the flushing fluid can be estimated without directly observing the sliding portions of the rotary sealing ring and the stationary sealing ring.

(5) Preferably, the cooling state estimation method of (4) above further includes a step of calculating a coefficient of kinetic friction of the sliding portions, based on the detected temperature difference.

In this case, since the coefficient of kinetic friction is closely related to the cooling state of the sliding portions, the cooling state of the sliding portions of the rotary sealing ring and the stationary sealing ring by the flushing fluid can be more accurately estimated from the coefficient of kinetic friction.

(6) Preferably, the cooling state estimation method of (5) above further includes a step of estimating the cooling state of the sliding portions, based on the calculated coefficient of kinetic friction and a characteristic curve showing behavior of the coefficient of kinetic friction with respect to a dimensionless coefficient for lubrication characteristics of the sliding portions.

In this case, by using the characteristic curve showing the behavior of the coefficient of kinetic friction with respect to the dimensionless coefficient for the lubrication characteristics of the sliding portions, which lubrication region the sliding portions are in can be estimated with high accuracy. Accordingly, the cooling state of the sliding portions of the rotary sealing ring and the stationary sealing ring by the flushing fluid can be more accurately estimated based on the estimated lubrication region.

### Advantageous Effects of the Invention

According to the present disclosure, the cooling state of the sliding portions of the rotary sealing ring and the stationary sealing ring by the flushing fluid can be estimated without directly observing the sliding portions.

### BRIEF DESCRIPTION OF DRAWINGS

FIG. 1 is a cross-sectional view of a mechanical seal according to a first embodiment of the present disclosure.

FIG. 2 is an enlarged cross-sectional view showing an adapter ring and an area therearound.

FIG. 3 is a schematic configuration diagram of a thermocouple.

FIG. 4 is a flowchart showing a method for estimating a cooling state of sliding portions of a rotary sealing ring and a stationary sealing ring by a flushing fluid.

FIG. 5 is a graph showing a characteristic curve.

FIG. 6 is a cross-sectional view showing a main part of a mechanical seal according to a second embodiment of the present disclosure.

### DETAILED DESCRIPTION

Next, preferred embodiments of the present disclosure will be described with reference to the accompanying drawings. At least parts of the embodiments described below may be combined as desired.

### First Embodiment

### <Entire Configuration>

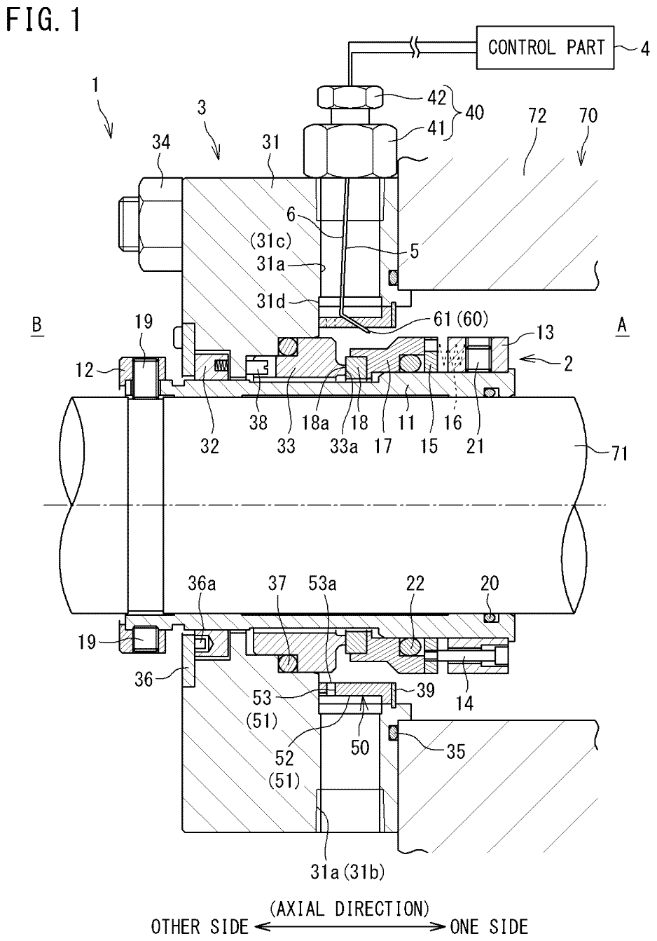

FIG. 1 is a cross-sectional view of a mechanical seal 1 according to a first embodiment of the present disclosure. In FIG. 1, the mechanical seal 1 is used in a rotary machine 70 such as a pump and seals a sealing target fluid inside the rotary machine 70. The mechanical seal 1 is placed along the axial direction of a rotary shaft 71 of the rotary machine 70 (hereinafter simply referred to as “axial direction”) between the rotary shaft 71 and a casing 72 surrounding the rotary shaft 71.

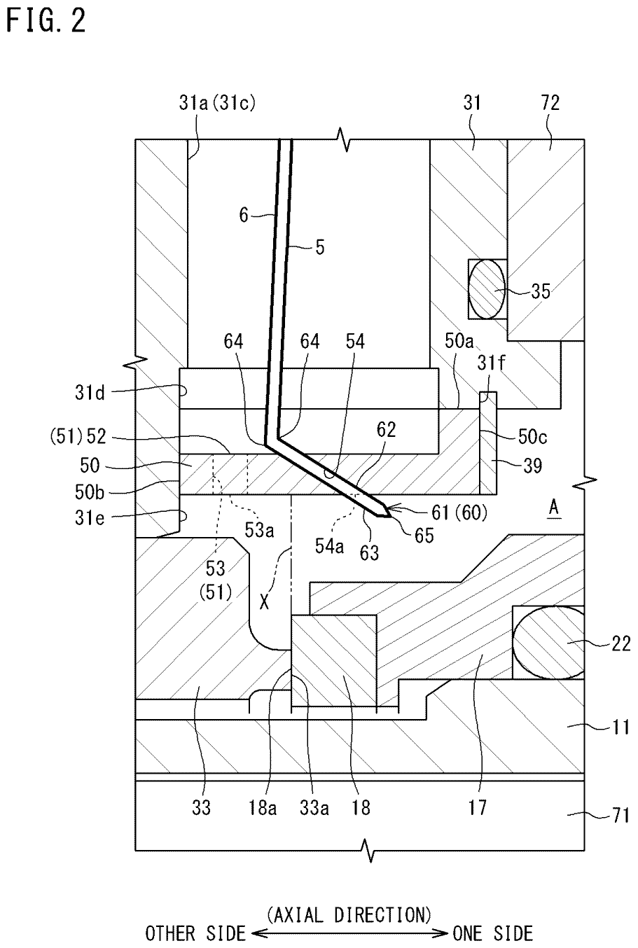

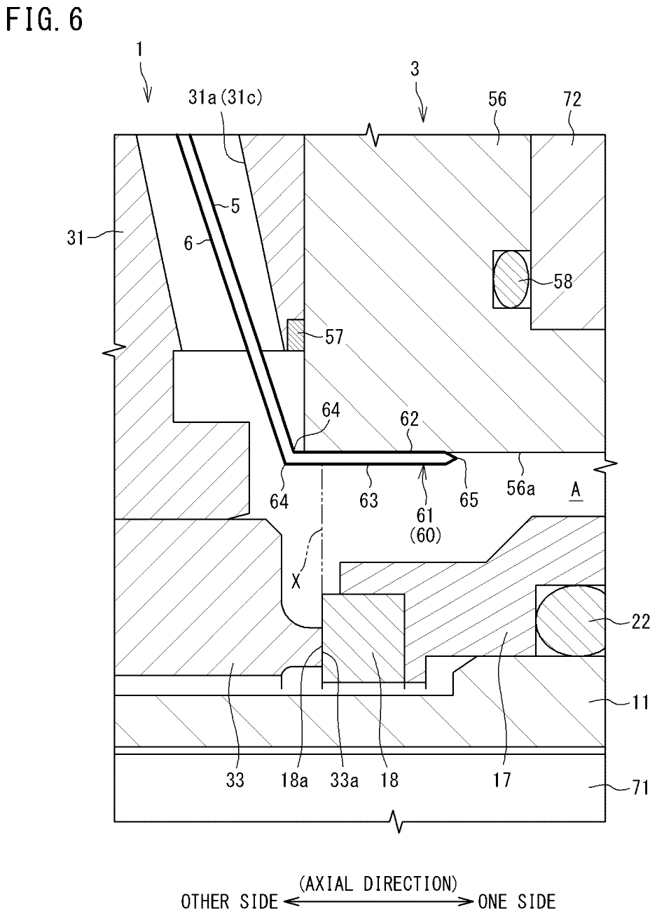

The mechanical seal 1 of the present embodiment includes a rotary side unit 2 provided on the rotary shaft 71 so as to be rotatable therewith, and a stationary side unit 3 provided on the casing 72. In the present specification, for convenience, the right side of FIG. 1 is referred to one side in the axial direction, and the left side of FIG. 1 is referred to as another side in the axial direction (the same applies to FIG. 2 and FIG. 6).

### <Rotary Side Unit>

The rotary side unit 2 includes a sleeve 11, a stopper ring 12, a first retainer 13, drive pins 14, a drive collar 15, springs 16, a second retainer 17, and a rotary sealing ring 18.

The sleeve 11 is formed in a cylindrical shape and is fitted to the outer circumference of the rotary shaft 71. The stopper ring 12 is fitted to the outer circumference of the sleeve 11 on the other side in the axial direction. A plurality of set screws 19 are screwed into the stopper ring 12 in the radial direction so as to be arranged in the circumferential direction of the stopper ring 12. Accordingly, the sleeve 11 is fixed to the rotary shaft 71. An O-ring 20 seals (secondarily seals) between the inner circumferential surface of the sleeve 11 on the one side in the axial direction and the outer circumferential surface of the rotary shaft 71.

The first retainer 13 is a spring retainer. The first retainer 13 is formed in an annular shape and is fitted to the outer circumference of the sleeve 11 on the one side in the axial direction. A plurality of set screws 21 (only one is shown in FIG. 1) are screwed into the first retainer 13 in the radial direction so as to be arranged in the circumferential direction of the first retainer 13. Accordingly, the first retainer 13 is fixed to the sleeve 11. The plurality of drive pins 14 (only one is shown in FIG. 1) extend through the first retainer 13 in the axial direction so as to be spaced apart from each other in the circumferential direction. The drive pins 14 are held so as to be movable in the axial direction with respect to the first retainer 13.

The drive collar 15 is placed on the other side in the axial direction of the first retainer 13 so as to be spaced apart therefrom. The drive collar 15 is formed in an annular shape and is fitted on the outer circumferential surface of the sleeve 11 so as to be movable in the axial direction with respect to this outer circumferential surface. An end portion on the other side in the axial direction of each drive pin 14 is fixed (screwed) to the drive collar 15. Accordingly, the drive collar 15 is held so as to be movable in the axial direction with respect to the first retainer 13 via the drive pins 14 and is restricted from rotating relative to the first retainer 13.

The plurality of springs 16 (only one is shown in FIG. 1) are provided between the drive collar 15 and the first retainer 13 so as to be spaced apart from each other in the circumferential direction. Each spring 16 biases the drive collar 15 against the first retainer 13 toward the other side in the axial direction.

The second retainer 17 is placed adjacently on the other side in the axial direction of the drive collar 15. The second retainer 17 is formed in an annular shape and is fitted on the outer circumferential surface of the sleeve 11 so as to be movable in the axial direction with respect to this outer circumferential surface. An end portion on the one side in the axial direction of the second retainer 17 is fixed to the drive collar 15. Accordingly, the second retainer 17 is restricted from rotating relative to the drive collar 15, while being held so as to be moveable in the axial direction with respect to the sleeve 11 together with the drive collar 15. An O-ring 22 seals (secondarily seals) between the inner circumferential surface of the second retainer 17 and the outer circumferential surface of the sleeve 11.

The rotary sealing ring 18 is formed in an annular shape and is fixed (shrink-fitted) to another end portion in the axial direction of the second retainer 17. A sealing surface 18a is formed on the end surface on the other side in the axial direction of the rotary sealing ring 18 (see also FIG. 2). The rotary sealing ring 18 is biased toward the other side in the axial direction via the drive collar 15 and the second retainer 17 by the springs 16.

### <Stationary Side Unit>

The stationary side unit 3 includes a seal case 31, a bushing 32, a stationary sealing ring 33, and an adapter ring 50. The seal case 31 is formed in a cylindrical shape. The seal case 31 is fixed to the casing 72 so as to surround the rotary shaft 71 in order to demarcate an inside region A and an outside region B of the rotary machine 70.

In the present embodiment, a radially outer portion of the seal case 31 is fixed to the casing 72 by a bolt 34 in a state of being in contact with the side surface on the other side in the axial direction of the casing 72. An O-ring 35 seals (secondarily seals) between the side surface on the one side in the axial direction of the seal case 31 and the side surface on the other side in the axial direction of the casing 72.

The bushing 32 is mounted on the inner circumference of the seal case 31 on the other side in the axial direction. The bushing 32 is formed in an annular shape and forms a clearance seal between the outer circumferential surface of the sleeve 11 and the bushing 32. An annular restriction member 36 is fixed to the end surface on the other side in the axial direction of the seal case 31.

The end surface on the other side in the axial direction of the bushing 32 is in contact with the restriction member 36. Accordingly, the bushing 32 is restricted from being pulled out from the seal case 31 to the other side in the axial direction. The restriction member 36 has an engagement pin 36a that is engaged with the bushing 32. Accordingly, the restriction member 36 restricts the bushing 32 from rotating together with the sleeve 11.

The stationary sealing ring 33 is formed in an annular shape and is fitted and fixed to the inner circumferential surface of the seal case 31. An O-ring 37 seals (secondarily seals) between the outer circumferential surface of the stationary sealing ring 33 and the inner circumferential surface of the seal case 31. A sealing surface 33a is formed on the end surface on the one side in the axial direction of the stationary sealing ring 33 (see also FIG. 2)

The sealing surface 18a of the rotary sealing ring 18 slides on the sealing surface 33a of the stationary sealing ring 33. Accordingly, the sealing target fluid is sealed in the inside region A. The stationary sealing ring 33 is restricted from rotating relative to the rotary sealing ring 18, by a restriction pin 38 fixed to the inner circumference of the seal case 31.

The adapter ring 50 is placed radially outward of sliding portions (sealing surfaces 18a and 33a) of the rotary sealing ring 18 and the stationary sealing ring 33 in the inside region A. Hereinafter, the sliding portions of the rotary sealing ring 18 and the stationary sealing ring 33 are also referred to as sliding portions 18a and 33a. The adapter ring 50 is formed in a cylindrical shape and is detachably provided on the seal case 31.

FIG. 2 is an enlarged cross-sectional view showing the adapter ring 50 and an area therearound. In FIG. 1 and FIG. 2, the one side in the axial direction of an outer circumferential surface 50a of the adapter ring 50 is fitted to the inner circumferential surface of the seal case 31. An end surface 50b on the other side in the axial direction of the adapter ring 50 is in contact with a step surface 31e extending in the radial direction on the inner circumference of the seal case 31.

An end surface 50c on the one side in the axial direction of the adapter ring 50 is in contact with a snap ring 39 mounted on the seal case 31. Accordingly, the adapter ring 50 is held between the step surface 31e and the snap ring 39, so that the adapter ring 50 is held such that the adapter ring 50 does not come out of the seal case 31.

The snap ring 39 is detachably fitted into an annular recessed groove 31f formed on the inner circumference of the seal case 31. Therefore, the adapter ring 50 can be detached from the seal case 31 by detaching the snap ring 39 from the recessed groove 31f.

### <Flow Passage for Flushing Fluid>

In FIG. 1, a flow passage for supplying a flushing fluid from the outside region B to the inside region A is formed in the stationary side unit 3. The flushing fluid cools and lubricates the sliding portions 18a and 33a of the rotary sealing ring 18 and the stationary sealing ring 33. In the present embodiment, a sealing target fluid is used as the flushing fluid.

In the present specification, the flushing fluid before cooling the sliding portions 18a and 33a is referred to as first flushing fluid. The flushing fluid after cooling the sliding portions 18a and 33a is referred to as second flushing fluid. A flow passage through which the first flushing fluid flows is formed in the stationary side unit 3. The flow passage for the first flushing fluid will be described below.

A plurality of holes 31a (two in FIG. 1) are formed on the one side in the axial direction of the seal case 31 so as to be spaced apart from each other in the circumferential direction of the seal case 31. Each hole 31a is formed so as to penetrate the seal case 31 in the radial direction. An annular groove 31d (see also FIG. 2) which communicates with each hole 31a is formed on the inner circumference of the seal case 31. Each hole 31a can be used as a first flow passage 31b for supplying the first flushing fluid from the outside region B to the inside region A.

The reason why the plurality of holes 31a each of which can be used as the first flow passage 31b are formed in the circumferential direction of the seal case 31 is that the position in the circumferential direction where a pipe through which the first flushing fluid flows is connected to the seal case 31 is different depending on the type of the rotary machine 70, etc. In the present embodiment, the hole 31a formed on the lower side of FIG. 1 is used as the first flow passage 31b. Therefore, the first flow passage 31b for supplying the first flushing fluid from the outside region B to the inside region A is formed at a predetermined location in the circumferential direction of the seal case 31 (the lower side of FIG. 1).

The other hole 31a which is not used as the first flow passage 31b is hereinafter also referred to as spare hole 31c. The opening on the radially outer side of each spare hole 31c is blocked by a blocking member 40. The blocking member 40 has, for example, a first screw portion 41 that is screwed into the spare hole 31c and a second screw portion 42 that is screwed into the head of the first screw portion 41. The blocking member 40 inhibits the first flushing fluid flowing from the annular groove 31d into the spare hole 31c from leaking to the outside.

In FIG. 2, the adapter ring 50 has a second flow passage 51 which communicates with the plurality of holes 31a (the first flow passage 31b and the spare hole 31c) of the seal case 31. The second flow passage 51 is a flow passage for supplying the first flushing fluid from the first flow passage 31b toward a plurality of locations in the circumferential direction of the sliding portions 18a and 33a. The second flow passage 51 has an annular flow passage 52 and a plurality of supply flow passages 53.

The annular flow passage 52 is formed on the outer circumference of the adapter ring 50 at a position opposing the annular groove 31d of the seal case 31. The annular flow passage 52 of the present embodiment is composed of an annular cut groove formed on the outer circumference of the adapter ring 50. The axial width of the annular flow passage 52 is the same as the groove width of the annular groove 31d of the seal case 31. Due to the above, the first flushing fluid from the first flow passage 31b flows in the circumferential direction in a flow passage composed of the annular groove 31d and the annular flow passage 52.

In FIG. 1 and FIG. 2, the plurality of supply flow passages 53 are flow passages for supplying the first flushing fluid from the annular flow passage 52 to the inside region A. The supply flow passages 53 are formed so as to penetrate the adapter ring 50 in the radial direction from a plurality of locations in the circumferential direction on the bottom surface of the annular flow passage 52. Accordingly, the first flushing fluid is supplied from the plurality of supply flow passages 53 to the inside region A, so that the sliding portions 18a and 33a can be uniformly cooled and lubricated over the entireties thereof in the circumferential direction.

Each supply flow passage 53 is formed such that an opening 53a on the radially inner side thereof is located on the other side in the axial direction (outside region B side) with respect to the sliding portions 18a and 33a. Accordingly, in the inside region A, the first flushing fluid and the second flushing fluid are generally separated into both sides in the axial direction, respectively, with an extension virtual line X of the sliding portions 18a and 33a as a boundary. Specifically, in the inside region A, the first flushing fluid occupies the region on the other side in the axial direction with respect to the extension virtual line X, and the second flushing fluid occupies the region on the one side in the axial direction with respect to the extension virtual line X.

### <Temperature Difference Detection Part>

The mechanical seal 1 further includes a temperature difference detection part 60 provided in the stationary side unit 3, and a control part 4. The temperature difference detection part 60 detects a temperature difference ΔT between a temperature T1 of the first flushing fluid and a temperature T2 of the second flushing fluid. The temperature difference detection part 60 of the present embodiment is composed of a single thermocouple 61. The thermocouple 61 of the present embodiment is mounted on the adapter ring 50.

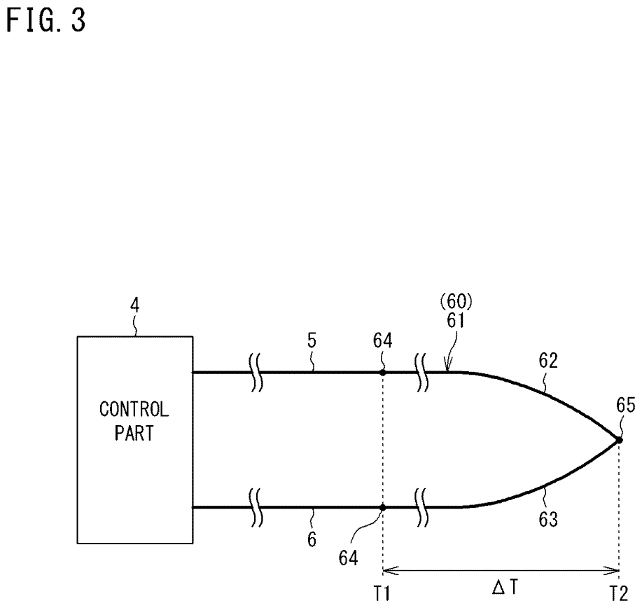

FIG. 3 is a schematic configuration diagram of the thermocouple 61. In FIG. 2 and FIG. 3, the thermocouple 61 is a thermocouple using the Seebeck effect. The thermocouple 61 has a first conductor 62 and a second conductor 63 made of metal materials different from each other. The first conductor 62 is made of, for example, an alloy mainly composed of nickel and chromium. The second conductor 63 is made of, for example, an alloy mainly composed of nickel and aluminum.

The first conductor 62 and the second conductor 63 are mounted by being inserted into a mounting hole 54 formed so as to penetrate the adapter ring 50 in the radial direction. The mounting hole 54 is formed at a position, corresponding to the spare hole 31c, in the adapter ring 50. In addition, the mounting hole 54 is formed so as to be inclined from the other side to the one side in the axial direction as extending from the outer circumferential surface toward the inner circumferential surface of the adapter ring 50. An opening 54a on the radially inner side of the mounting hole 54 is positioned in the region on the one side in the axial direction with respect to the extension virtual line X (the region occupied by the second flushing fluid) in the inside region A.

The mounting hole 54 is sealed by a sealing member, which is not shown, in a state where the first conductor 62 and second conductor 63 extend through the mounting hole 54. This sealing member inhibits the first flushing fluid flowing through the annular flow passage 52 from flowing through the mounting hole 54 into the region occupied by the second flushing fluid in the inside region A.

One end of the first conductor 62 and one end of the second conductor 63 are joined to each other in a state of protruding from the opening 54a of the mounting hole 54 into the region on the one side in the axial direction of the inside region A. This joint point is defined as a temperature measuring contact 65 of the thermocouple 61. Therefore, the temperature measuring contact 65 of the thermocouple 61 in the present embodiment is located so as to be in contact with the second flushing fluid.

The other end of the first conductor 62 and the other end of the second conductor 63 are placed in the annular flow passage 52, through which the first flushing fluid flows, so as to project radially outward from the mounting hole 54 and be separated from each other. The other end of the first conductor 62 and the other end of the second conductor 63 which are placed in the annular flow passage 52 are defined as reference contacts 64 of the thermocouple 61, respectively. Therefore, the reference contacts 64 of the thermocouple 61 in the present embodiment are placed so as to be in contact with the first flushing fluid in the annular flow passage 52.

The other end of the first conductor 62 is connected by welding or the like to a connection conductive wire 5 made of a metal material different from the first conductor 62 and the second conductor 63. The other end of the second conductor 63 is connected by welding or the like to a connection conductive wire 6 made of a metal material different from the first conductor 62 and the second conductor 63. Each connection conductive wire 5 or 6 is composed of a conductive wire made of copper, for example.

As shown in FIG. 1 and FIG. 2, each connection conductive wire 5 or 6 passes from the reference contact 64 of the thermocouple 61 through the annular flow passage 52 and the spare hole 31c, and extends through the blocking member 40 to the radially outer side of the seal case 31 (outside region B). An end portion of each connection conductive wire 5 or 6 in the outside region B is connected to the control part 4.

Due to the above configuration, the thermocouple 61 outputs a thermoelectromotive force corresponding to the temperature difference ΔT occurring between the temperature T1 of the reference contact 64 (first flushing fluid) and the temperature T2 of the temperature measuring contact 65 (second flushing fluid), to the control part 4 via the connection conductive wires 5 and 6. That is, when the thermocouple 61 detects the temperature difference ΔT between the temperature T1 of the first flushing fluid and the temperature T2 of the second flushing fluid, the thermocouple 61 outputs a signal (thermoelectromotive force) corresponding to the temperature difference ΔT, to the control part 4. The thermocouple 61 detects the temperature difference ΔT and outputs the signal to the control part 4 every predetermined time.

### <Control Part>

The control part 4 is placed in the outside region B. The control part 4 is configured to include a computer having a CPU, etc. Each function of the control part 4 is performed by the CPU executing a control program stored in a storage device of the computer. The control part 4 calculates a coefficient of kinetic friction u of the sliding portions 18a and 33a, based on the thermoelectromotive force inputted from the thermocouple 61 every predetermined time. A specific method of the calculation will be described below.

First, the control part 4 extracts the temperature difference ΔT corresponding to the thermoelectromotive force inputted from the thermocouple 61, for example, from a table in which the thermoelectromotive force and the temperature difference ΔT are registered in association with each other. The control part 4 may calculate the temperature difference ΔT using a predetermined calculation formula from the thermoelectromotive force inputted from the thermocouple 61.

Next, the control part 4 calculates the coefficient of kinetic friction u by substituting the extracted temperature difference ΔT into equation (3) derived from equations (1) and (2) below. Equation (1) is an equation representing a frictional heat quantity Q [KJ/min] of the sliding portions 18a and 33a. Equation (2) is an equation representing a flow rate Wf [L/min] of the flushing fluid required to cool the sliding portions 18a and 33a.

$$Q = ( μ \cdot P \cdot V ) \times 60 \div 1000 \qquad ( 1 )$$

$$Wf = Q \div ( Cp \cdot γ \cdot Δ T ) \qquad ( 2 )$$

$$μ = Wf \times ( Cp \cdot γ \cdot Δ T ) \div ( P \cdot V ) \times 1000 \div 60 \qquad ( 3 )$$

Here, P is an apparent thrust [N] applied to the sliding portions 18a and 33a. Vis the average peripheral speed [m/s] of the sealing surface 18a of the rotary sealing ring 18. Cp is the specific heat [KJ/kgK] of the flushing fluid. γ is the density [kg/L] of the flushing fluid. ΔT is the temperature difference [K] between the temperature T1 of the first flushing fluid and the temperature T2 of the second flushing fluid. P, V, Cp, and γ are all known values.

### <Method for Estimating Cooling State of Sliding Portions>

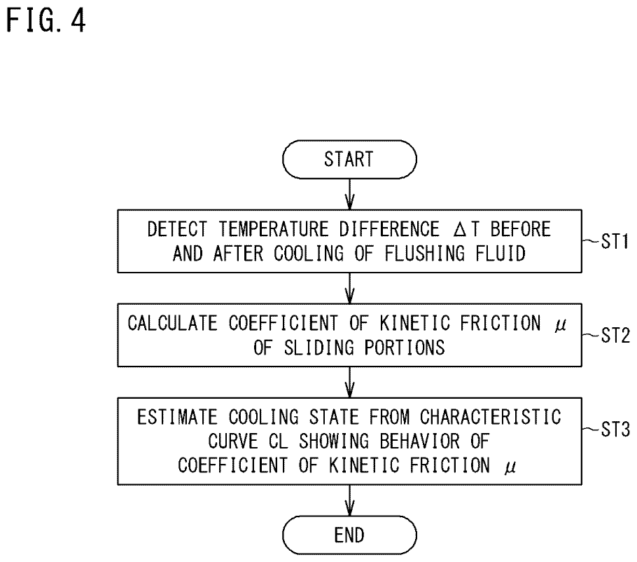

FIG. 4 is a flowchart showing a method for estimating a cooling state of the sliding portions 18a and 33a of the rotary sealing ring 18 and the stationary sealing ring 33 by the flushing fluid. The method for estimating the cooling state will be described below with reference to FIG. 4.

First, the temperature difference before and after cooling of the flushing fluid, that is, the temperature difference ΔT between the temperature T1 of the first flushing fluid and the temperature T2 of the second flushing fluid, is detected by the temperature difference detection part 60 (step ST1). The temperature difference detection part 60 outputs the thermoelectromotive force corresponding to the temperature difference ΔT, to the control part 4 as described above.

Next, in the control part 4, the coefficient of kinetic friction u of the sliding portions 18a and 33a is calculated based on the temperature difference ΔT (step ST2). A specific method for calculating the coefficient of kinetic friction u by the control part 4 is as described above.

Next, the cooling state of the sliding portions 18a and 33a is estimated based on the calculated coefficient of kinetic friction u and a characteristic curve CL (step ST3). The characteristic curve CL is a curve that shows the behavior of the coefficient of kinetic friction μ with respect to a dimensionless coefficient for the lubrication characteristics of the sliding portions 18a and 33a. The estimation of the cooling state of the sliding portions 18a and 33a is performed, for example, by a business entity who performs maintenance and inspection of the mechanical seal 1.

As the dimensionless coefficient, for example, a duty parameter DP is used. The duty parameter DP represents the characteristics (lubrication characteristics) of a lubricating film of the flushing fluid formed on the sliding portions 18a and 33a. The duty parameter DP is calculated from equation (4) below.

$$DP = ( η \times ω \times b ) \div W \qquad ( 4 )$$

Here, η is the viscosity [Pa·s] of the flushing fluid. ω is the peripheral speed [m/s] of the sealing surface 18a of the rotary sealing ring 18. b is the radial sliding width [m] of the sealing surface 18a. W is a pressing load [N] to the rotary sealing ring 18 by the springs 16 (see FIG. 1) and the sealing target fluid.

The characteristic curve CL of the present embodiment shows the behavior of the coefficient of kinetic friction u with respect to the duty parameter DP. The characteristic curve CL is created in advance by performing a test or the like for the static load capacity of the mechanical seal 1 while varying the duty parameter DP. The characteristic curve CL is a curve that is different depending on the type of the flushing fluid, etc.

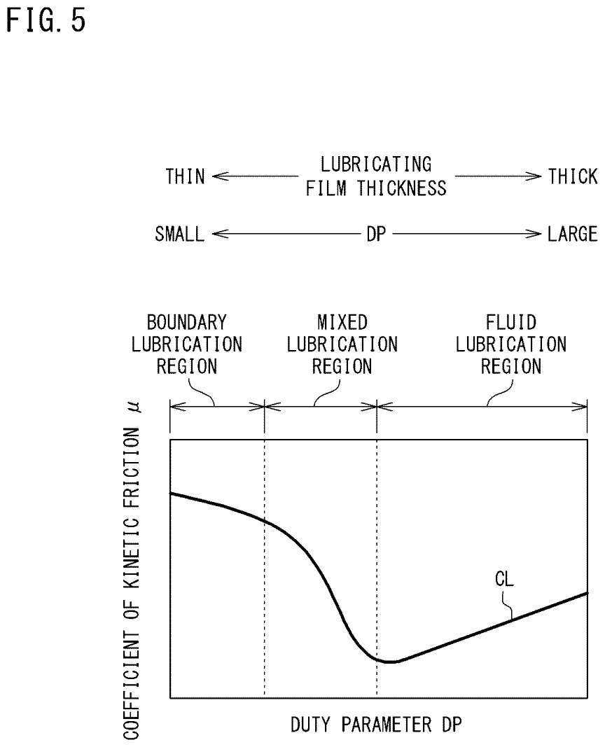

FIG. 5 is a graph showing the characteristic curve CL created by the above test or the like. In this graph, the vertical axis indicates the coefficient of kinetic friction μ, and the horizontal axis indicates the duty parameter DP. As shown in FIG. 5, the value of the coefficient of kinetic friction μ of the sliding portions 18a and 33a generally changes along the characteristic curve CL in accordance with the value of the duty parameter DP. Due to this change in the value of the coefficient of kinetic friction μ, the state of the lubricating film of the flushing fluid formed on the sliding portions 18a and 33a changes.

As shown in FIG. 5, the state of the lubricating film of the flushing fluid changes into three regions in accordance with the value of the duty parameter DP. Specifically, the state of the lubricating film of the flushing fluid changes in the order of a boundary lubrication region, a mixed lubrication region, and a fluid lubrication region as the value of the duty parameter DP increases.

In the boundary lubrication region, the coefficient of kinetic friction μ is relatively large, and the thickness of the lubricating film of the flushing fluid is relatively thin. Therefore, in the boundary lubrication region, the amount of the flushing fluid supplied to the sliding portions 18a and 33a is insufficient, so that the sealing surfaces 18a and 33a easily come into direct contact with each other and the amount of wear thereof tends to increase. In the mixed lubrication region, the coefficient of kinetic friction μ is in a proper range, and the thickness of the lubricating film of the flushing fluid is also in a proper range. In the fluid lubrication region, the coefficient of kinetic friction μ is relatively small, and the thickness of the lubricating film of the flushing fluid is relatively thick. Therefore, the sealing target fluid easily leaks at the sliding portions 18a and 33a.

When estimating the cooling state of the sliding portions 18a and 33a from the characteristic curve CL in FIG. 5, the business entity first identifies the position where the calculated value of the coefficient of kinetic friction μ by the control part 4 is located on the characteristic curve CL. The characteristic curve CL has substantially a V-shape having a valley at the position where the coefficient of kinetic friction μ reaches its minimum value (near the boundary between the mixed lubrication region and the fluid lubrication region). Therefore, the calculated value of the coefficient of kinetic friction μ may show the same value on the characteristic curve CL in the mixed lubrication region and on the characteristic curve CL in the fluid lubrication region.

In such a case, the business entity calculates the value of the duty parameter DP corresponding to the used flushing fluid, using equation (4) above. Then, the business entity identifies the position where the calculated value of the coefficient of kinetic friction μ is located on the characteristic curve CL, by whether the calculated value of the duty parameter DP is greater than or less than the value (boundary value) of the duty parameter DP corresponding to the minimum value of the coefficient of kinetic friction μ.

Specifically, if the calculated value of the duty parameter DP is greater than the boundary value, the business entity can identify that the calculated value of the coefficient of kinetic friction μ is located on the characteristic curve CL in the fluid lubrication region. If the calculated value of the duty parameter DP is less than the boundary value, the business entity can identify that the calculated value of the coefficient of kinetic friction μ is located on the characteristic curve CL in the mixed lubrication region. The boundary value of the duty parameter DP is a known value that is generally constant for each flushing fluid, etc.

Next, the business entity checks which of the boundary lubrication region, the mixed lubrication region, and the fluid lubrication region includes the position identified on the characteristic curve CL in the graph in FIG. 5. The business entity can estimate the cooling state of the sliding portions 18a and 33a by the region including the position identified on the characteristic curve CL.

Specifically, if the position identified on the characteristic curve CL is included in the boundary lubrication region, the thickness of the lubricating film of the flushing fluid is relatively thin as described above, so that the cooling state of the sliding portions 18a and 33a can be estimated to be a state where the amount of the flushing fluid supplied to the sliding portions 18a and 33a is insufficient.

If the position identified on the characteristic curve CL is included in the mixed lubrication region, the thickness of the lubricating film of the flushing fluid is in the proper range as described above, so that the cooling state of the sliding portions 18a and 33a can be estimated to be a state where the sliding portions 18a and 33a are appropriately cooled.

If the point identified on the characteristic curve CL is included in the fluid lubrication region, the thickness of the lubricating film of the flushing fluid is relatively thick as described above, so that the cooling state of the sliding portions 18a and 33a can be estimated to be a state where the sealing target fluid easily leaks at the sliding portions 18a and 33a.

In the present embodiment, the business entity estimates the cooling state of the sliding portions 18a and 33a, based on the characteristic curve CL and the coefficient of kinetic friction μ calculated based on the temperature difference ΔT, but the cooling state of the sliding portions 18a and 33a may be estimated from the temperature difference ΔT. In this case, if the temperature difference ΔT is relatively large, the heat generation at the sliding portions 18a and 33a is increased due to frictional heat, etc., so that the cooling state of the sliding portions 18a and 33a can be roughly estimated to be a state where the amount of the flushing fluid supplied to the sliding portions 18a and 33a is insufficient. If the temperature difference ΔT is relatively small, the heat generation at the sliding portions 18a and 33a is reduced to be low, so that the cooling state of the sliding portions 18a and 33a can be roughly estimated to be a state where the sliding portions 18a and 33a are appropriately cooled by the flushing fluid.

The business entity may also estimate the cooling state of the sliding portions 18a and 33a from the coefficient of kinetic friction μ calculated based on the temperature difference ΔT. In this case, since the coefficient of kinetic friction μ is closely related to the cooling state of the sliding portions 18a and 33a, the cooling state of the sliding portions 18a and 33a can be estimated more accurately than from the temperature difference ΔT.

### Advantageous Effects

In the mechanical seal 1 of the present embodiment, the temperature difference ΔT between the temperature T1 of the first flushing fluid before cooling and the temperature T2 of the second flushing fluid after cooling is detected by the temperature difference detection part 60. The cooling state of the sliding portions 18a and 33a of the rotary sealing ring 18 and the stationary sealing ring 33 can be roughly estimated by the detected temperature difference ΔT. Therefore, the business entity can estimate the cooling state of the sliding portions 18a and 33a by the flushing fluid without directly observing the sliding portions 18a and 33a of the rotary sealing ring 18 and the stationary sealing ring 33.

The temperature difference detection part 60 is the thermocouple 61 having the reference contacts 64 and the temperature measuring contact 65, each reference contact 64 is placed so as to be in contact with the second flushing fluid, and the temperature measuring contact 65 is placed so as to be in contact with the first flushing fluid. Therefore, the temperature difference between the reference contact 64 and the temperature measuring contact 65 of the thermocouple 61 is the temperature difference ΔT between the temperature T1 of the first flushing fluid before cooling and the temperature T2 of the second flushing fluid after cooling. Thus, by using the thermocouple 61, the temperature difference detection part 60 can have a simple configuration.

The control part 4 calculates the coefficient of kinetic friction μ of the sliding portions 18a and 33a, based on the temperature difference ΔT detected by the temperature difference detection part 60. Since the coefficient of kinetic friction μ is closely related to the cooling state of the sliding portions 18a and 33a, the business entity can more accurately estimate the cooling state of the sliding portions 18a and 33a if the business entity uses the calculated coefficient of kinetic friction μ. In addition, equation (3) above for calculating the coefficient of kinetic friction μ includes the characteristics (the density γ, etc.) of the flushing fluid and the operating conditions (the thrust P, the average peripheral speed V, etc.) of the mechanical seal 1. Therefore, the calculated coefficient of kinetic friction μ is a numerical value that takes more into account the differences in flushing fluid and operating conditions, when compared to the temperature difference ΔT, so that it is easier to compare the cooling state of the sliding portions 18a and 33a under various conditions than from the temperature difference ΔT.

When estimating the cooling state of the sliding portions 18a and 33a, the business entity uses the characteristic curve CL which shows the behavior of the coefficient of kinetic friction μ with respect to the duty parameter DP for the lubrication characteristics of the sliding portions 18a and 33a. By the characteristic curve CL, which of the three lubrication regions (the boundary lubrication region, the mixed lubrication region, and the fluid lubrication region) the sliding portions 18a and 33a are in can be estimated with high accuracy. Accordingly, the business entity can more accurately estimate the cooling state of the sliding portions 18a and 33a, based on the estimated lubrication region. In addition, it may be difficult to estimate which of the mixed lubrication region and the fluid lubrication region the value of the coefficient of kinetic friction μ calculated by the control part 4 is in. In such a case, which of the mixed lubrication region and the fluid lubrication region the calculated value of the coefficient of kinetic friction μ is located in can be easily identified by using the characteristic curve CL and the boundary value of the duty parameter DP corresponding to the minimum value of the coefficient of kinetic friction μ.

### Second Embodiment

FIG. 6 is a cross-sectional view showing a main part of a mechanical seal 1 according to a second embodiment of the present disclosure. In FIG. 6, the mechanical seal 1 of the present embodiment is different from that of the first embodiment in the mounting structure for the thermocouple 61 in the stationary side unit 3. The stationary side unit 3 of the present embodiment includes an adjustment ring 56 provided between the seal case 31 and the casing 72.

The adjustment ring 56 is formed in an annular shape and is fixed to the casing 72 together with the seal case 31 by the bolt 34 (see FIG. 1). When fixing the adjustment ring 56 to the casing 72, an adjustment ring 56 having a different size is used in accordance with the type of the rotary machine 70. Accordingly, the mechanical seal 1 can be attached to various rotary machines 70.

An inner circumferential surface 56a of the adjustment ring 56 is located radially outward of the sliding portions 18a and 33a. A gasket 57 seals (secondarily seals) between the side surface on the one side in the axial direction of the seal case 31 and the side surface on the other side in the axial direction of the adjustment ring 56. An O-ring 58 seals (secondarily seals) between the side surface on the one side in the axial direction of the adjustment ring 56 and the side surface on the other side in the axial direction of the casing 72.

The stationary side unit 3 of the present embodiment does not include the adapter ring 50 (see FIG. 2). In addition, the annular groove 31d (see FIG. 2) which communicates with each hole 31a is not formed on the inner circumference of the seal case 31. Therefore, each hole 31a (the first flow passage 31b, the spare hole 31c) of the seal case 31 directly communicates with the inside region A.

The thermocouple 61 of the present embodiment is mounted on the adjustment ring 56. Specifically, the first conductor 62 and the second conductor 63 of the thermocouple 61 are fixed at a position close to the spare hole 31c on the inner circumferential surface 56a of the adjustment ring 56. For clarity, in FIG. 6, the second conductor 63 is shown so as to be displaced radially inward from the inner circumferential surface 56a of the adjustment ring 56.

The first conductor 62 and the second conductor 63 are placed so as to intersect the extension virtual line X of the sliding portions 18a and 33a in the axial direction. Accordingly, the reference contacts 64 of the thermocouple 61 are placed so as to be in contact with the first flushing fluid, and the temperature measuring contact 65 of the thermocouple 61 is placed so as to be in contact with the second flushing fluid.

Each reference contact 64 of the thermocouple 61 is connected to the corresponding connection conductive wire 5 or 6 in a state of protruding to the other side in the axial direction with respect to the adjustment ring 56. Each connection conductive wire 5 or 6 passes from the reference contact 64 of the thermocouple 61 through the spare hole 31c and extends through the blocking member 40 to the radially outer side of the seal case 31 (outside region B) (see FIG. 1).

The other components of the present embodiment are the same as in the first embodiment, and thus are designated by the same reference signs, and the description thereof is omitted. In the mechanical seal 1 of the present embodiment, the same effects as those of the first embodiment are achieved.

### [Others]

In the thermocouple 61 of each embodiment above, each reference contact 64 is placed so as to be in contact with the first flushing fluid, and the temperature measuring contact 65 is placed so as to be in contact with the second flushing fluid, but each reference contact 64 may be placed so as to be in contact with the second flushing fluid, and the temperature measuring contact 65 may be placed so as to be in contact with the first flushing fluid.

The temperature difference detection part 60 of each embodiment above is composed of the thermocouple 61, but is not limited thereto. For example, the temperature difference detection part 60 may include a pair of temperature sensors that detect the temperature T1 of the first flushing fluid and the temperature T2 of the second flushing fluid, respectively. Specifically, in the case of through-flushing in which a self-flushing pipe and a reverse-flushing pipe are included in the stationary side unit 3, the temperature difference detection part 60 may include a temperature sensor that is provided in the self-flushing pipe and detects the temperature T1 of the first flushing fluid in this pipe, and a temperature sensor that is provided in the reverse-flushing pipe and detects the temperature T2 of the second flushing fluid in this pipe.

The temperature difference detection part 60 of each embodiment above is mounted on the adapter ring 50 or the adjustment ring 56, but may be mounted on another member included in the stationary side unit 3. In each embodiment above, each connection conductive wire 5 or 6 passes through the spare hole 31c of the seal case 31. However, a dedicated hole through which each connection conductive wire 5 or 6 passes through may be formed in the seal case 31. Alternatively, each connection conductive wire 5 or 6 may pass through a hole that is formed in advance in the casing 72 of the rotary machine 70 and is for water injection.

In each embodiment above, the coefficient of kinetic friction μ is automatically calculated by the control part 4, but the coefficient of kinetic friction μ may be manually calculated by the business entity or the like. The mechanical seal 1 of each embodiment above is a rotary type mechanical seal, but is not limited thereto. For example, the mechanical seal 1 may be a stationary, dual seal (tandem seal, double seal), one-coil, or bellows type mechanical seal, or may be a mechanical seal in which thermosiphon occurs without actively circulating a flushing fluid, such as a double seal using a pressure tank.

The embodiments disclosed herein are merely illustrative and not restrictive in all aspects. The scope of the present invention is defined by the scope of the claims rather than the meaning described above, and is intended to include meaning equivalent to the scope of the claims and all modifications within the scope.

### REFERENCE SIGNS LIST

1 mechanical seal
2 rotary side unit
3 stationary side unit
4 control part
18 rotary sealing ring
18a, 33a sliding portion
33 stationary sealing ring
60 temperature difference detection part
61 thermocouple
64 reference contact
65 temperature measuring contact
71 rotary shaft
72 casing
A inside region
CL characteristic curve
DP duty parameter (dimensionless coefficient)
T1 temperature
T2 temperature
ΔT temperature difference
μ coefficient of kinetic friction

1. A mechanical seal including:
a rotary side unit provided on a rotary shaft so as to be rotatable therewith and having a rotary sealing ring; and
a stationary side unit provided on a casing surrounding the rotary shaft and having a stationary sealing ring on which the rotary sealing ring slides to seal a sealing target fluid in an inside region in the casing, sliding portions of the rotary sealing ring and the stationary sealing ring being cooled by a flushing fluid,
the mechanical seal comprising
a temperature difference detection part provided in the stationary side unit and configured to detect a temperature difference between a temperature of a first flushing fluid that is the flushing fluid before cooling the sliding portions and a temperature of a second flushing fluid that is the flushing fluid after cooling the sliding portions.

2. The mechanical seal according to claim 1, further comprising a control part configured to calculate a coefficient of kinetic friction of the sliding portions, based on the temperature difference.

3. The mechanical seal according to claim 1, wherein
the temperature difference detection part is a thermocouple having a reference contact and a temperature measuring contact,
the reference contact is placed so as to be in contact with one of the first flushing fluid and the second flushing fluid, and
the temperature measuring contact is placed so as to be in contact with the other of the first flushing fluid and the second flushing fluid.

4. A cooling state estimation method for, in a mechanical seal including: a rotary side unit provided on a rotary shaft so as to be rotatable therewith and having a rotary sealing ring; and a stationary side unit provided on a casing surrounding the rotary shaft and having a stationary sealing ring on which the rotary sealing ring slides to seal a sealing target fluid in an inside region in the casing, estimating a cooling state of sliding portions of the rotary sealing ring and the stationary sealing ring by a flushing fluid, the cooling state estimation method comprising
a step of detecting, by a temperature difference detection part, a temperature difference between a temperature of the flushing fluid before cooling the sliding portions and a temperature of the flushing fluid after cooling the sliding portions.

5. The cooling state estimation method according to claim 4, further comprising a step of calculating a coefficient of kinetic friction of the sliding portions, based on the detected temperature difference.

6. The cooling state estimation method according to claim 5, further comprising a step of estimating the cooling state of the sliding portions, based on the calculated coefficient of kinetic friction and a characteristic curve showing behavior of the coefficient of kinetic friction with respect to a dimensionless coefficient for lubrication characteristics of the sliding portions.
